(19) United States
(12) Patent Application Publication
(10) Pub. No.: US 2026/0152680 A1
(43) Pub. Date: Jun. 4, 2026

(54) TWO-COMPONENT POLYURETHANE COMPOSITION WITH ADJUSTABLE POT LIFE FOR SPRAY APPLICATION

(71) Applicant: SIKA TECHNOLOGY AG, Baar (CH)

(72) Inventors: Zong CHENG, Shanghai (CN); Pengfei WANG, Suzhou (CN)

(73) Assignee: SIKA TECHNOLOGY AG, Baar (CH)

(21) Appl. No.: 19/125,501

(22) PCT Filed: Dec. 1, 2022
(86) PCT No.: PCT/CN2022/135940

§ 371 Date: Apr. 29, 2025

(51) Int. Cl. C09J 175/06; C08G 18/22; C08G 18/87; C09J 5/00

(52) U.S. Cl. CPC C09J 175/06; C08G 18/227; C08G 18/87; C09J 5/00; C08G 2170/00

(57) ABSTRACT

A polyurethane composition including first and second component; wherein first component A includes: at least one polyol A1 having OH functionality ranging from 1.5 to 4 and a mean molecular weight ranging from 250 to 15 000 g/mol, and at least one diol A2 having two hydroxyl groups linked via C2 to C9 carbon chain, and at least one compound T having at least one thiol group; and second component B includes at least one polyisocyanate I.

### TECHNICAL FIELD

The invention relates to a two-component polyurethane composition and to the use thereof, in particular as an adhesive for bonding parts of the consumable electric device in a spray process.

### PRIOR ART

In the field of assembly of electronic products, especially consumable electronic products, hot melt adhesives are usually used to bond parts of electronic products, such as the frames of mobile phones and tablet computers. However, because of the chemical and physical properties of hot melt adhesives, such bonding is often time-consuming and expensive, and requires relatively harsh operating conditions.

In addition, the use of hot melt adhesives also makes it impossible to achieve the bonding of electronic product components with a spraying process that is more convenient and material-saving.

Two-component polyurethane compositions based on polyols and polyisocyanates have already been used for some time. Two-component polyurethane compositions have the advantage that they cure rapidly after mixing and can therefore absorb and transmit higher forces after just a short time. However, two component polyurethane compositions are usually used as structural adhesives or as matrix (binder) in composite materials.

There is a desire for an adhesive composition that are suitable for spray application with a very small amount, especially when used for bonding parts of the electric device, meanwhile having excellent mechanical properties and adhesion properties as well as a rapid curing behavior. In the meantime, it would additionally be desirable if the pot life of such compositions is able to be tailored to the desired use.

### SUMMARY OF THE INVENTION

The object of the present invention is therefore to provide a two-component polyurethane composition that cures very rapidly to form a mechanically excellent and chemically resistant mass, in particular when sprayed in a very small amount on the parts of the electric devices to bond them. At the same time it has a pot life that can be adjusted within certain limits, allowing it to be processed without problem.

This object is surprisingly achieved with the polyurethane composition according to the invention as claimed in claim 1. The composition comprises a polyol, a short-chain diol, and also a compound having at least one thiol group in the first component and a sufficient content of polyisocyanate in the second component. For curing the composition, the composition further contains a metal catalyst that is able to form thio complexes, with the ratio of thiol groups to metal atoms in the composition being fixed. It is important that the composition comprises a certain amount of an acrylonitrile and styrene grafted polyether polyol H in the first component and an isocyanate-group containing prepolymer P1, selected from either a polymer P1-1 based on at least one polyisocyanate, at least one polyether polyol and at least one hydroxy-terminated polybutadiene polymer, or from a polymer P1-2, based on at least one polyisocyanate and at least one polyether polyol.

Furthermore, it has been also found that the inventive polyurethane composition, when cured, may result in an adhesion failure on the substrate when being detached from the substrate on which it applied. In the electronic devices, the adhesion failure on the substrate may be desired especially for repairing some electronic elements, because the adhesive may be removed without any damages on the substrate such as cracks.

Further aspects of the invention are the subject of further independent claims. Particularly preferred embodiments of the invention are the subject of the dependent claims.

### WAYS OF CARRYING OUT THE INVENTION

In a first aspect, the present invention relates to a polyurethane composition consisting of a first and a second component; wherein
the first component A comprises
   at least one polyol A1 having an OH functionality in the range from 1.5 to 4 and a mean molecular weight in the range from 250 to 15 000 g/mol, and
   at least one diol A2 having two hydroxyl groups that are linked via a C2 to C9 carbon chain, and
   at least one compound T that has at least one thiol group; and
the second component B comprises
   at least one polyisocyanate I;
wherein one of the two components additionally comprises at least one metal catalyst K for the reaction of hydroxyl groups and isocyanate groups that is able to form thio complexes;
the first component A comprises an acrylonitrile and styrene grafted polyether polyol H in an amount of 7.5-25% by weight, and
the second component B comprises an isocyanate-group containing prepolymer P1, selected from either a polymer P1-1 based on at least one polyisocyanate, at least one polyether polyol and at least one hydroxy-terminated polybutadiene polymer, or from a polymer P1-2 based on at least one polyisocyanate and at least one polyether polyol.

In a second aspect, the present invention relates to a process for bonding substrates, especially parts of electric devices including:
mixing both components of the inventive polyurethane composition; and
spraying the mixed composition on the parts to be bonded.

The prefix “poly” in substance names such as “polyol”, “polyisocyanate”, “polyether” or “polyamine” in the present document indicates that the respective substance formally contains more than one of the functional group that occurs in its name per molecule. In the present document the term “polymer” firstly encompasses a group of macromolecules that are chemically uniform but differ in the degree of polymerization, molar mass, and chain length, said group having been produced by a “poly” reaction (polymerization, polyaddition, polycondensation). The term secondly also encompasses derivatives of such a group of macromolecules from poly reactions, i.e. compounds that have been obtained by reactions, for example additions or substitutions, of functional groups on defined macromolecules and that may be chemically uniform or chemically nonuniform. The term further encompasses so-called prepolymers as well, i.e. reactive initial oligomeric adducts, the functional groups of which are involved in the construction of macromolecules.

The term “polyurethane polymer” encompasses all polymers produced according to the so-called diisocyanate polyaddition process. This also includes polymers that are virtually or completely free of urethane groups. Examples of polyurethane polymers are polyether polyurethanes, polyester polyurethanes, polyether polyureas, polyureas, polyester polyureas, polyisocyanurates and polycarbodiimides.

In the present document, “molecular weight” is understood to mean the molar mass (in grams per mole) of a molecule or a molecule residue. “Mean molecular weight” refers to the number average Mn of a polydisperse mixture of oligomeric or polymeric molecules or molecule residues, which is typically determined by gel-permeation chromatography (GPC) against polystyrene as standard. In the present document, “room temperature” refers to a temperature of 23° C. Percent by weight values, abbreviated wt.-%, refer to the proportions by mass of a constituent in a composition based on the overall composition, unless otherwise stated. The terms “mass” and “weight” are used synonymously in the present document.

A “primary hydroxyl group” refers to an OH group attached to a carbon atom having two hydrogens.

In this document, the “pot life” refers to the time within which, after mixing the two components, the polyurethane composition can be processed before the viscosity resulting from the progression of the crosslinking reaction has become too high for further processing.

The term “strength” in the present document refers to the strength of the cured composition, with strength meaning in particular the tensile strength and modulus of elasticity, particularly within the 0.05% to 0.25% region of elongation.

In the present document, “room temperature” refers to a temperature of 23° C.

A substance or composition is described as “storage-stable” or “storable” if it can be stored at room temperature in a suitable container over a prolonged period, typically for at least 3 months up to 6 months or more, without this storage resulting in any change in its application or use properties, particularly in the viscosity and crosslinking rate, to an extent relevant to the use thereof.

All industry standards and norms mentioned in this document relate to the versions valid at the date of first filing.

The first component A comprises firstly at least one polyol A1 having an OH functionality in the range from 1.5 to 4 and a mean molecular weight in the range from 250 to 15 000 g/mol.

Suitable polyols A1 are in principle all polyols currently used in the production of polyurethane polymers. Particularly suitable are polyether polyols, polyester polyols, poly(meth)acrylate polyols, polybutadiene polyols, polycarbonate polyols, and also mixtures of these polyols.

Suitable polyether polyols, also known as polyoxyalkylene polyols or oligoetherols, are in particular those that are polymerization products of ethylene oxide, 1,2-propylene oxide, 1,2- or 2,3-butylene oxide, oxetane, tetrahydrofuran or mixtures thereof, optionally polymerized with the aid of a starter molecule having two or more active hydrogen atoms such as water, ammonia or compounds having a plurality of OH or NH groups, for example 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline, and mixtures of the recited compounds.

Employable are both polyoxyalkylene polyols having a low degree of unsaturation (measured according to ASTM D-2849-69 and expressed in milliequivalents of unsaturation per gram of polyol (mEq/g)), produced for example using so-called double metal cyanide complex catalysts (DMC catalysts), and polyoxyalkylene polyols having a relatively high degree of unsaturation, produced for example using anionic catalysts such as NaOH, KOH, CsOH or alkali metal alkoxides.

Particularly suitable are polyoxyethylene polyols and polyoxypropylene polyols, in particular polyoxyethylene diols, polyoxypropylene diols, polyoxyethylene triols, and polyoxypropylene triols.

Particularly suitable are polyoxyalkylene diols or polyoxyalkylene triols having a degree of unsaturation lower than 0.02 mEq/g and having a molecular weight in the range from 1000 to 15 000 g/mol, as are polyoxyethylene diols, polyoxyethylene triols, polyoxypropylene diols and polyoxypropylene triols having a molecular weight of 400 to 15 000 g/mol.

Likewise particularly suitable are so-called ethylene oxide-terminated (EO-endcapped/ethylene oxide-endcapped) polyoxypropylene polyols. The latter are special polyoxypropylene polyoxyethylene polyols that are obtained for example when pure polyoxypropylene polyols, in particular polyoxypropylene diols and triols, after completion of the polypropoxylation reaction, are further alkoxylated with ethylene oxide and thus have primary hydroxyl groups. Preferred in this case are polyoxypropylene polyoxyethylene diols and polyoxypropylene polyoxyethylene triols.

Also suitable are hydroxyl-terminated polybutadiene polyols, for example those produced by polymerization of 1,3-butadiene and allyl alcohol or by oxidation of polybutadiene and also the hydrogenation products thereof.

Also suitable are styrene-acrylonitrile grafted polyether polyols such as those commercially available under the trade name Lupranol® from Elastogran GmbH, Germany.

Suitable polyester polyols include in particular polyesters that bear at least two hydroxyl groups and are produced by known processes, in particular polycondensation of hydroxycarboxylic acids or polycondensation of aliphatic and/or aromatic polycarboxylic acids with dihydric or polyhydric alcohols.

More suitable are polyester polyols produced from dihydric to trihydric alcohols such as 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the abovementioned alcohols with organic dicarboxylic acids or the anhydrides or esters thereof, for example succinic acid, glutaric acid, adipic acid, trimethyladipic acid, suberic acid, azelaic acid, sebacic acid, dodecanedicarboxylic acid, maleic acid, fumaric acid, dimer fatty acid, phthalic acid, phthalic anhydride, isophthalic acid, terephthalic acid, dimethyl terephthalate, hexahydrophthalic acid, trimellitic acid and trimellitic anhydride or mixtures of the abovementioned acids, as are polyester polyols formed from lactones such as ε-caprolactone.

Particularly suitable are polyester diols, in particular those produced from adipic acid, azelaic acid, sebacic acid, dodecanedicarboxylic acid, dimer fatty acid, phthalic acid, isophthalic acid and terephthalic acid as the dicarboxylic acid or from lactones such as ε-caprolactone and from ethylene glycol, diethylene glycol, neopentyl glycol, 1,4-butanediol, 1,6-hexanediol, dimer fatty acid diol, and 1,4-cyclohexanedimethanol as the dihydric alcohol.

Suitable polycarbonate polyols include in particular those obtainable by reaction for example of the abovementioned alcohols used to construct the polyester polyols with dialkyl carbonates such as dimethyl carbonate, diaryl carbonates such as diphenyl carbonate, or phosgene. Likewise suitable are polycarbonates obtainable from the copolymerization of CO₂ with epoxides such as ethylene oxide and propylene oxide.

Polycarbonate diols, in particular amorphous polycarbonate diols, are particularly suitable.

Further suitable polyols are poly(meth)acrylate polyols.

Also suitable are polyhydroxy-functional fats and oils, for example natural fats and oils, in particular castor oil, or so-called oleochemical polyols obtained by chemical modification of natural fats and oils, the epoxy polyesters or epoxy polyethers obtained for example by epoxidation of unsaturated oils and subsequent ring opening with carboxylic acids or alcohols respectively, or polyols obtained by hydroformylation and hydrogenation of unsaturated oils. Also suitable are polyols obtained from natural fats and oils by degradation processes such as alcoholysis or ozonolysis and subsequent chemical linking, for example by transesterification or dimerization, of the thus obtained degradation products or derivatives thereof. Suitable degradation products of natural fats and oils are in particular fatty acids and fatty alcohols and also fatty acid esters, in particular the methyl esters (FAME), which can be derivatized to hydroxy fatty acid esters, for example by hydroformylation and hydrogenation.

Likewise suitable are, in addition, polyhydrocarbon polyols, also referred to as oligohydrocarbonols, for example polyhydroxy-functional ethylene-propylene, ethylene-butylene or ethylene-propylene-diene copolymers, for example those produced by Kraton Polymers, USA, or polyhydroxy-functional copolymers of dienes, such as 1,3-butanediene or diene mixtures, and vinyl monomers such as styrene, acrylonitrile or isobutylene, or polyhydroxy-functional polybutadiene polyols, for example those which are produced by copolymerization of 1,3-butadiene and allyl alcohol and which may also be hydrogenated.

Also suitable are polyhydroxy-functional acrylonitrile/butadiene copolymers, such as those that can be produced from epoxides or amino alcohols and carboxyl-terminated acrylonitrile/butadiene copolymers, which are commercially available under the name Hypro® (formerly Hycar®) CTBN from Emerald Performance Materials, LLC, USA.

All recited polyols have a mean molecular weight from 250 to 15 000 g/mol, preferably from 400 to 10 000 g/mol, more preferably from 1000 to 8000 g/mol and a mean OH functionality in the range from 1.5 to 4, preferably 1.7 to 3. However, it is entirely possible for the composition to also include proportions of monools (polymers having only one hydroxyl group).

Particularly suitable polyols are polyester polyols and polyether polyols, in particular polyoxyethylene polyol, polyoxypropylene polyol, and polyoxypropylene polyoxyethylene polyol, preferably polyoxyethylene diol, polyoxypropylene diol, polyoxyethylene triol, polyoxypropylene triol, polyoxypropylene polyoxyethylene diol, and polyoxypropylene polyoxyethylene triol.

The first component A further comprises at least one diol A2 having two hydroxyl groups that are linked via a C2 to C9 carbon chain.

Suitable as diol A2 are linear or branched alkylene diols having two primary or secondary hydroxyl groups, alkylene diols having one primary and one secondary hydroxyl group, and cycloaliphatic diols.

The diol A2 is preferably a linear aliphatic diol having two primary hydroxyl groups that are linked via a C4 to C9 carbon chain.

In particular, the diol A2 is selected from the group consisting of ethylene glycol, 1,3-propanediol, 1,4-butanediol, 1,5-pentanediol, 1,6-hexanediol, 1,7-heptanediol, 1,8-octanediol, 1,9-nonanediol, 1,3-butanediol, 2,3-butanediol, 2-methyl-1,3-propanediol, 1,2-pentanediol, 2,4-pentanediol, 2-methyl-1,4-butanediol, 2,2-dimethyl-1,3-propanediol (neopentyl glycol), 1,2-hexanediol, 1,4-butanediol, 3-methyl-1,5-pentanediol, 1,2-octanediol, 3,6-octanediol, 2-ethyl-1,3-hexanediol, 2,2,4-trimethyl-1,3-pentanediol, 2-butyl-2-ethyl-1,3-propanediol, 2,7-dimethyl-3,6-octanediol, 1,4-cyclohexanediol, 1,3-cyclohexanedimethanol, and 1,4-cyclohexanedimethanol.

The diol A2 is more preferably selected from the group consisting of 1,4-butanediol, 1,5-pentanediol, 1,6-hexanediol, 1,7-heptanediol, 1,8-octanediol, and 1,9-nonanediol.

The diol A2 is most preferably selected from the group consisting of 1,4-butanediol, 1,5-pentanediol, 1,6-hexanediol, and 1,9-nonanediol. These diols are commercially readily available and provide polyurethanes having particularly high moduli of elasticity at low elongation when cured.

The first component A preferably comprises between 5 and 25% by weight of diol A2.

One of the essences of the instant invention is that the first component A comprises an acrylonitrile and styrene grafted polyether polyol H, which is important for implementing the desired spraying application and improving the adhesion property of the substrates to be bonded. Necessarily, the amount of the polyether polyol H is in a range of 7.5-25% by weight, preferably 12.0-20.0% by weight based on the overall polyurethane composition. It has been found that the spraying application may become difficult if using the polyether polyol H in an amount exceeding 25% by weight. In some cases, more than 25% by weight may also probably worsen the mechanics such as the elongation at break.

Such an acrylonitrile and styrene grafted polyether polyol is a polyether based on polyether polyol grafted with acrylonitrile, styrene monomer, and may be obtained by free radical graft polymerization under specific temperature and nitrogen protection and with the aid of an initiator. The polyether polyol suitable as a starter to be grated may be those listed above as preferred polyether polyols.

The acrylonitrile and styrene grafted polyether polyol H may be available on the market under the trademark such as CHP-H45 from Changhua Chemical.

In addition to these recited polyols A1, A2 and H, it is possible to include small amounts of further low-molecular-weight dihydric or polyhydric alcohols such as diethylene glycol, triethylene glycol, the isomeric dipropylene glycols and tripropylene glycols, the isomeric decanediols and undecanediols, hydrogenated bisphenol A, dimeric fatty alcohols, 1,1,1-trimethylolethane, 1,1,1-trimethylolpropane, glycerol, pentaerythritol, sugar alcohols such as xylitol, sorbitol or mannitol, sugars such as sucrose, other higher polyhydric alcohols, low-molecular-weight alkoxylation products of the abovementioned dihydric and polyhydric alcohols, and also mixtures of the abovementioned alcohols. In addition, polyols containing other heteroatoms, for example methyldiethanolamine or thiodiglycol, may also be included.

The first component A further comprises at least one compound T that has at least one thiol group. Suitable are all compounds that have at least one thiol/mercapto group and that can be formulated into the composition according to the invention. A thiol group is understood here as meaning an —SH group that is attached to an organic radical, for example an aliphatic, cycloaliphatic or aromatic carbon radical.

Preference is given to compounds having 1 to 6, more preferably 1 to 4, most preferably 1 or 2 thiol groups. Compounds having a thiol group have the advantage that they do not form complexes with the metal catalyst K, which tend to be poorly soluble, and that the pot life can be adjusted particularly precisely. Compounds having two thiol groups have the advantage that the mechanical properties of the composition after curing are improved.

Examples of suitable compounds T having a thiol group are 3-mercaptopropyltrimethoxysilane, 3-mercaptopropyltriethoxysilane, 3-mercapto-1,2-propanediol, 2-mercaptotoluimidazole or 2-mercaptobenzothiazole.

Examples of suitable compounds T having more than one thiol group are ethylene glycol di(3-mercaptopropionate), ethylene glycol dimercaptoacetate, dipentaerythritol hexa(3-mercaptopropionate), 2,3-dimercapto-1,3,4-thiadiazole or pentaerythritol tetrakis(3-mercaptopropionate).

The compound T is preferably selected from the group consisting of ethylene glycol di(3-mercaptopropionate), ethylene glycol dimercaptoacetate, dipentaerythritol hexa(3-mercaptopropionate), and 3-mercaptopropyl trimethoxysilane.

The molar ratio of all the thiol groups in the at least one compound T to all metal atoms in the at least one metal catalyst K may be between 1:1 and 250:1. It is preferably between 2:1 and 150:1, more preferably between 5:1 and 100:1. This quantitive ratio allows the pot life to be adjusted, specifically within the intrinsic limits of the particular composition, through, for example, the content of catalyst, the reactivity of the isocyanates present, and the amount thereof. The lower limit of the pot life is the pot life that is obtained in a given composition when using a defined amount of catalyst without addition of compound T. The upper limit of the adjustable pot life is accordingly the pot life that would be achieved through the uncatalyzed isocyanate-hydroxyl reaction if a catalyst is not used. Even without the use of a catalyst, this reaction will commence at some point after mixing the two components. However, the reaction without catalyst proceeds more slowly and with the development of poorer mechanical properties in the cured material.

The key advantage achieved by the two-component polyurethane composition according to the invention is a system that cures and hardens with extraordinary rapidity, while at the same time having an adequately long pot life that allows it to be processed in a user-friendly manner. A further advantage of the polyurethane compositions according to the invention is the possibility of being able to adjust the pot life as described above. This is very advantageous particularly in automated applications and can, for example, allow further optimization of throughput times in industrial production, since the pot life can be tailored to the desired use.

The second component B comprises firstly at least one polyisocyanate I.

The polyisocyanate I is present in relatively high amounts, which is very advantageous for the development of mechanical properties.

The second component may contain preferably sufficient polyisocyanate I for it to comprise at least 5% by weight, preferably at least 6% by weight, more preferably at least 7.5% by weight of isocyanate groups based on the overall polyurethane composition.

All commercially available polyisocyanates suitable for polyurethane production, in particular diisocyanates, may be used as polyisocyanates I for the production of the polyurethane polymer in the composition according to the invention.

Suitable polyisocyanates are in particular monomeric di- or triisocyanates and also oligomers, polymers, and derivatives of monomeric di- or triisocyanates, and any mixtures thereof.

Suitable aromatic monomeric di- or triisocyanates are in particular tolylene 2,4- and 2,6-diisocyanate and any mixtures of these isomers (TDI), diphenylmethane 4,4′-, 2,4′-, and 2,2′-diisocyanate and any mixtures of these isomers (MDI), mixtures of MDI and MDI homologs (polymeric MDI or PMDI), 1,3- and 1,4-phenylene diisocyanate, 2,3,5,6-tetramethyl-1,4-diisocyanatobenzene, naphthalene 1,5-diisocyanate (NDI), 3,3′-dimethyl-4,4′-diisocyanatodiphenyl (TODI), dianisidine diisocyanate (DADI), 1,3,5-tris(isocyanatomethyl)benzene, tris(4-isocyanatophenyl)methane, and tris(4-isocyanatophenyl) thiophosphate.

Suitable aliphatic monomeric di- or triisocyanates are in particular tetramethylene 1,4-diisocyanate, 2-methylpentamethylene 1,5-diisocyanate, hexamethylene 1,6-diisocyanate (HDI), 2,2,4- and 2,4,4-trimethylhexamethylene 1,6-diisocyanate (TMDI), decamethylene 1,10-diisocyanate, dodecamethylene 1,12-diisocyanate, lysine diisocyanate and lysine ester diisocyanate, cyclohexane 1,3- and 1,4-diisocyanate, 1-methyl-2,4- and -2,6-diisocyanatocyclohexane and any mixtures of these isomers (HTDI or H₆TDI), 1-isocyanato-3,3,5-trimethyl-5-isocyanatomethylcyclohexane (=isophorone diisocyanate or IPDI), perhydrodiphenylmethane 2,4′- and 4,4′-diisocyanate (HMDI or H₁₂MDI), 1,4-diisocyanato-2,2,6-trimethylcyclohexane (TMCDI), 1,3- and 1,4-bis(isocyanatomethyl)cyclohexane, m- and p-xylylene diisocyanate (m- and p-XDI), m- and p-tetramethylxylylene 1,3- and 1,4-diisocyanate (m- and p-TMXDI) and bis(1-isocyanato-1-methylethyl)naphthalene, dimer and trimer fatty acid isocyanates such as 3,6-bis(9-isocyanatononyl)-4,5-di-(1-heptenyl)cyclohexene (dimeryl diisocyanate), and α,α,α′,α′,α″,α″-hexamethyl-1,3,5-mesitylene triisocyanate.

Preference among these is given to MDI, TDI, HDI, and IPDI.

Suitable oligomers, polymers, and derivatives of the recited monomeric di- and triisocyanates are in particular those derived from MDI, TDI, HDI, and IPDI. Particularly suitable among these are commercially available types, in particular HDI biurets such as Desmodur® N 100 and N 3200 (from Covestro), Tolonate® HDB and HDB-LV (from Vencorex), and Duranate® 24A-100 (from Asahi Kasei); HDI isocyanurates such as Desmodur® N 3300, N 3600, and N 3790 BA (all from Covestro), Tolonate® HDT, HDT-LV, and HDT-LV2 (from Vencorex), Duranate® TPA-100 and THA-100 (from Asahi Kasei), and Coronate® HX (from Nippon Polyurethane); HDI uretdiones such as Desmodur® N 3400 (from Covestro); HDI iminooxadiazinediones such as Desmodur® XP 2410 (from Covestro); HDI allophanates such as Desmodur® VP LS 2102 (from Covestro); IPDI isocyanurates, for example in solution as Desmodur® Z 4470 (from Covestro) or in solid form as Vestanat® T1890/100 (from Evonik); TDI oligomers such as Desmodur® IL (from Covestro); and also mixed isocyanurates based on TDI/HDI, for example as Desmodur® HL (from Covestro). Also particularly suitable are MDI forms that are liquid at room temperature (so-called “modified MDI”), which are mixtures of MDI with MDI derivatives such as, in particular, MDI carbodiimides or MDI uretonimines or MDI urethanes, known by trade names such as Desmodur® CD, Desmodur® PF, Desmodur® PC (all from Covestro) or Isonate® M 143 (from Dow), and mixtures of MDI and MDI homologs (polymeric MDI or PMDI), available under trade names such as Desmodur® VL, Desmodur® VL50, Desmodur® VL R10, Desmodur® VL R20, Desmodur® VH 20 N, and Desmodur® VKS 20F (all from Covestro), Isonate® M 309, Voranate® M 229 and Voranate® M 580 (all from Dow) or Lupranat® M 10 R (from BASF). The abovementioned oligomeric polyisocyanates are in practice typically mixtures of substances having different degrees of oligomerization and/or chemical structures. They preferably have a mean NCO functionality of 2.1 to 4.0.

The polyisocyanate is preferably selected from the group consisting of MDI, TDI, HDI, and IPDI, and oligomers, polymers, and derivatives of the recited isocyanates, and mixtures thereof.

The polyisocyanate preferably contains isocyanurate, iminooxadiazinedione, uretdione, biuret, allophanate, carbodiimide, uretonimine or oxadiazinetrione groups.

Particularly preferred polyisocyanates are MDI forms that are liquid at room temperature. These are, in particular, so-called polymeric MDI and also MDI containing proportions of oligomers or derivatives thereof. The content of MDI (=diphenylmethane 4,4′-, 2,4′- or 2,2′-diisocyanate and any mixtures of these isomers) in such liquid MDI forms is preferably 50 to 95% by weight, more preferably 60 to 90% by weight. More particularly preferred as the polyisocyanate is polymeric MDI and MDI forms that are liquid at room temperature and contain proportions of MDI carbodiimides or their adducts.

With these polyisocyanates, particularly good processing properties and particularly high strengths are obtained.

The polyisocyanate of the second component may contain proportions of polyurethane polymers having isocyanate groups. Either the second component may comprise a polyurethane polymer having isocyanate groups that was produced separately, or the polyisocyanate has been mixed with at least one polyol, in particular a polyether polyol, with the isocyanate groups present in a stoichiometric excess over the OH groups.

As pointed out above, it is important in the instant application to include an isocyanate-group containing prepolymer P1, selected from either a polymer P1-1 based on at least one polyisocyanate, at least one polyether polyol and at least one hydroxy-terminated polybutadiene polymer, or from a polymer P1-2, based on at least one polyisocyanate and at least one polyether polyol in the second component B or in the polyisocyanate I.

The polyisocyanate and polyether polyol as specified above and the preferable forms thereof also apply for those used for preparing the isocyanate-group containing prepolymer P1.

In one advantageous embodiment, the polyisocyanates used for prepolymers P1-1 and P1-2 may include aromatic monomeric di- or triisocyanates in particular tolylene 2,4- and 2,6-diisocyanate and any mixtures of these isomers (TDI), diphenylmethane 4,4′-, 2,4′-, and 2,2′-diisocyanate and any mixtures of these isomers (MDI), mixtures of MDI and MDI homologs (polymeric MDI or PMDI), 1,3- and 1,4-phenylene diisocyanate, 2,3,5,6-tetramethyl-1,4-diisocyanatobenzene, naphthalene 1,5-diisocyanate (NDI), 3,3′-dimethyl-4,4′-diisocyanatodiphenyl (TODI), dianisidine diisocyanate (DADI), 1,3,5-tris(isocyanatomethyl)benzene, tris(4-isocyanatophenyl)methane, and tris(4-isocyanatophenyl) thiophosphate.

The suitable polyisocyanate for prepolymer P1 may be also preferably selected from the aromatic diisocyanate or triisocyanate such as MDI or TDI, especially MDI, and oligomers, polymers, and derivatives of the recited isocyanates, and mixtures thereof.

The polyisocyanate for prepolymer P1 may preferably contain isocyanurate, iminooxadiazinedione, uretdione, biuret, allophanate, carbodiimide, uretonimine or oxadiazinetrione groups.

In one advantageous embodiment, the amount of the isocyanate-group containing prepolymer P1 is in a range of 10% to 40% by weight, preferably 18% to 36% by weight, based on the overall composition.

The molar ratio of NCO groups to OH groups during reaction for preparing the prepolymer P1 may be normally in the range of between 2.1:1 and 3:1. In one advantageous embodiment, the content of NCO group contained in prepolymer P1 may be in a range of 8% to 12% by weight.

In the composition according to the invention, polyisocyanate I is preferably present in an amount from 10% by weight to 40% by weight, more preferably from 15% by weight to 35% by weight, particularly preferably from 20% by weight to 30% by weight, based on component B.

The first component A and/or the second component B further comprises at least one metal catalyst K for the reaction of hydroxyl groups and isocyanate groups that is able to form thio complexes. Suitable metal catalysts K are thus all metal catalysts that may be used as a crosslinking catalyst in polyurethane chemistry and that can at the same time form thio complexes with thiols in the presence thereof.

The metal catalyst K is preferably present only in the first component A. This has the advantage of achieving better storage stability.

Examples of suitable metal catalysts are bismuth, zinc, tin or zirconium compounds, including complexes and salts of these metals.

The metal catalyst K preferably comprises a bismuth compound, in particular a bismuth(III) compound. In addition to the desired properties as a catalyst able to form thio complexes, bismuth compounds have the advantage of low acute toxicity.

A multiplicity of conventional bismuth catalysts may be used as the bismuth compound. Examples are bismuth carboxylates, for example bismuth acetate, oleate, octoate or neodecanoate, bismuth nitrate, bismuth halides such as the bromide, chloride, or iodide, bismuth sulfide, basic bismuth carboxylates such as bismuthyl neodecanoate, bismuth subgallate or bismuth subsalicylate, and mixtures thereof.

In a preferred embodiment, the metal catalyst K is a bismuth(III) complex containing at least one ligand based on 8-hydroxyquinoline. Such complexes are described in EP 1551895. This is preferably a bismuth(III) carboxylate containing one molar equivalent of an 8-hydroxyquinoline ligand.

In a further preferred embodiment, the metal catalyst K is a bismuth(III) complex containing at least one ligand based on a 1,3-ketoamide. Such complexes are described in EP 2791153. This is preferably a bismuth(III) carboxylate containing 1 to 3 molar equivalents of a 1,3-ketoamide ligand.

The polyurethane composition may contain, in addition to the constituents already mentioned, further constituents as known to the person skilled in the art from two-component polyurethane chemistry. These may be present in just one component or in both.

Preferred further constituents are inorganic or organic fillers, such as, in particular, natural, ground or precipitated calcium carbonates, optionally coated with fatty acids, in particular stearic acid, baryte (heavy spar), talcs, quartz powders, quartz sand, dolomites, wollastonites, kaolins, calcined kaolins, mica (potassium aluminum silicate), molecular sieves, aluminum oxides, aluminum hydroxides, magnesium hydroxide, silicas including finely divided silicas from pyrolysis processes, industrially produced carbon blacks, graphite, metal powders such as aluminum, copper, iron, silver or steel, PVC powder or hollow spheres, and also flame-retardant fillers such as hydroxides or hydrates, in particular hydroxides or hydrates of aluminum, preferably aluminum hydroxide.

The addition of fillers is advantageous in that it increases the strength of the cured polyurethane composition.

The polyurethane composition preferably comprises at least one filler selected from the group consisting of calcium carbonate, carbon black, kaolin, baryte, talc, quartz powder, dolomite, wollastonite, kaolin, calcined kaolin, and mica. Particularly preferred as fillers are ground calcium carbonate, calcined kaolins or carbon black.

It may be advantageous to use a mixture of different fillers. Most preferred are combinations of ground calcium carbonates or calcined kaolins and carbon black.

The content of filler F in the composition is preferably in the range from 5% by weight to 50% by weight, more preferably 10% by weight to 40% by weight, particularly preferably 15% by weight to 30% by weight, based on the overall composition.

It is possible for further constituents to be additionally present, in particular solvents, plasticizers and/or extenders, pigments, rheology modifiers such as, in particular, amorphous silicas, desiccants such as, in particular, zeolites, adhesion promoters such as, in particular, organofunctional trialkoxysilanes, stabilizers against oxidation, heat, light, and UV radiation, flame-retardant substances, and also surface-active substances, in particular wetting agents and defoamers.

The polyurethane composition comprises preferably less than 0.5% by weight, in particular less than 0.1% by weight of carboxylic acids, based on the overall composition. Any carboxylate ligands introduced through the metal catalyst are not included here among the stated carboxylic acids.

A preferred polyurethane composition comprises a first component A comprising, based on the total weight of component A,
10 to 60% by weight, of polyol A1,
5 to 25% by weight, of diol A2,
10 to 45% by weight, of polyether polyol H,
1 to 5% by weight, of a compound T having at least one thiol group,
0.05 to 0.5% by weight, of a metal catalyst K, and
10 to 50% by weight, of fillers,
and optionally further constituents.

A preferred polyurethane composition comprises a second component B comprising 10% to 40% by weight, in particular 15% to 30% by weight, of polyisocyanate I, wherein the amount of the isocyanate-group containing prepolymer P1 is in a range of 25% to 75% by weight, preferably 35% to 70% by weight, based on the total weight of component B. In the instant application, the polyisocyanate I is the polyisocyanate compound as specified above but different from the isocyanate-group containing prepolymer P1.

It is advantageous if the first and second components are formulated so that their mixing ratio in parts by weight is in the range from 10:1 to 1:10, preferably from 5:1 to 1:5, in particular from 2:1 to 1:2 or about 1:1.

In the mixed polyurethane composition, the ratio before curing between the number of isocyanate groups and the number of groups reactive toward isocyanates is preferably approximately in the range of 1.2 to 1, more preferably 1.15 to 1.05. However, it is also possible, although not usually preferred, for the proportion of isocyanate groups to be substoichiometric with respect to groups reactive toward isocyanates.

The production of the two components is carried out separately and preferably with the exclusion of moisture. The two components are typically each stored in a separate container. The further constituents of the polyurethane composition may be present as a constituent of the first or second component, with further constituents that are reactive toward isocyanate groups preferably being a constituent of the first component. A suitable container for the storage of each component is in particular a drum, a hobbock, a bag, a bucket, a can, a cartridge or a tube. The components are both storage-stable, meaning that they can be stored prior to use for several months up to one year or longer, without any change in their respective properties to a degree relevant to their use.

The two components are stored separately prior to the mixing of the composition and are mixed with one another only on use or immediately prior to this. They are advantageously present in a package consisting of two separate chambers.

In a further aspect, the invention comprises a pack consisting of a package having two separate chambers which respectively contain the first component and the second component of the composition.

The mixing is typically effected via static mixers or with the aid of dynamic mixers. During mixing, care must be taken to ensure that the two components are mixed as homogeneously as possible. If the two components are mixed incompletely, local deviations from the advantageous mixing ratio will occur, which can result in a deterioration in the mechanical properties.

On contact of the first component with the second component, curing commences through chemical reaction. This involves reaction of the hydroxyl groups and any other substances present that are reactive toward isocyanate groups with the isocyanate groups. Excess isocyanate groups react predominantly with moisture. As a result of these reactions, the polyurethane composition cures to give a solid material. This operation is also referred to as crosslinking.

The invention thus also further provides a cured polyurethane composition obtained from the curing of the polyurethane composition as described in the present document.

The two-component polyurethane composition described is advantageously usable as an adhesive that may be applied in a spray process.

The invention thus also relates to a process for bonding substrates, especially parts of electric devices including the steps of:
mixing the first and second components of the polyurethane composition as described above,
spraying the mixed composition onto at least one of the substrate surfaces to be bonded,
joining the substrates to be bonded within the pot life, and
curing the polyurethane composition.

These two substrates may consist of the same material or different materials, and especially the parts of an electric device such as audio and video apparatus, information technology equipment, telecommunication terminal equipment, portable electronic devices, for example laptop, mobile phone, pad, tablet and so on.

One or both substrates is preferably made of a metal or a glass ceramic or a glass or a glass fiber-reinforced plastic or a carbon fiber-reinforced plastic or an epoxy-based thermoset.

If required, the substrates can be pretreated prior to application of the composition. Such pretreatments include, in particular, physical and/or chemical cleaning processes and the application of an adhesion promoter, an adhesion promoter solution or a primer.

The invention is further elucidated hereinafter by examples, but these are not intended to restrict the invention in any way.

### EXAMPLES

Substances used:

| | |
|---|---|
| Polyether polyol 1 | Polyether triol having a hydroxyl value 33-35 mg KOH/g and Mn |
| | 4800-5000 g/mol |
| 1,5-PDO | 1,5-Pentanediol |
| CHP-H45 | CHP-H45 (Changhua). Polyether polyol synthesized by free radical |
| | graft polymerization with initiator and monomers of styrene and |
| | acrylonitrile polyol (hydroxyl value 19-23 mg KOH/g; |
| | viscosity <6000 mPa · s at 25° C.) |
| Polyether polyol 2 | Polyether polyol having a hydroxyl value 380-420 mg KOH/g and a |
| | viscosity 330-410 mPa · s at 25° C. |
| Voranol EP 1900 | Polyether diol (hydroxyl value 28 mg KOH/g) |
| GDMP | Glycol di(3-mercaptopropionate) |
| Bi-cat | Coscat ® 83 (Vertellus Specialties Inc.). Organobismuth catalyst |
| | (2.68 mmol Bi/g) |
| Defoamer | Polyurethane defoamer |
| Chalk | CaCO₃ having a median particle size D50 of 4-7 micron |
| HDK-H18 | HDK ® H18 (Wacker). Pyrogenic Silica. Synthetic, hydrophobic, |
| | amorphous silica, produced via flame hydrolysis. |
| Suprasec 2020 | Suprasec ® 2020 (Covestro); Uretonimine-modified diphenyl |
| | methane diisocyanate (MDI) |
| Suprasec 2496 | Suprasec ® 2496 (Covestro). Low viscosity modified diphenyl |
| | methane diisocyanate (MDI) |
| Coronate MX | Coronate ® MX (Tosoh). MDI (Methylene diphenyl diisocyanate) |
| | partially converted to carbodiimide |
| PTSI | p-Toluene sulfonyl isocyanate (drying agent) |
| Kaolin | Clay filler |
| Monarch 570 | Monarch ® 570 (Cabot Corp.); Carbon black (filler) |
| Molecular sieve | Drying agent |

### Preparation of Polymer-7, -10 and -18

### Polymer-7 (Polymer P1-2):

250 g of polyoxypropylene triol (ZSN-330, GPRO group; OH value 56.5 mg KOH/g), 2500 g of polyoxypropylenepolyoxyethylene dial (DP-1000, GRPO group/Kukdo Chemical Company; OH value 112.0 mg KOH/g), 750 g polyoxypropylenepolyoxyethylene dial(VORANOL EP-1900), 1000 g of polymeric MDI 4,4′-methylene diphenyl diisocyanate (Suprasec® 2496, Huntsman), and 1250 g of modified MDI (Suprasec® 2020, Huntsman Shanghai) were reacted at 80° C. by a known method to give an NCO-terminated polyurethane polymer having a content of isocyanate groups of 9.2% by weight.

### Polymer-10 (Polymer P1-1):

750 g of polyoxypropylene trial (ZSN-330, GPRO group; OH value 56.5 mg KOH/g), 650 g polybutadiene dial (POLYVEST HT, OH value 44-51 mgKOH/g), 1° C. Og of polymeric MDI (4,4′-methylene diphenyl diisocyanate) (Suprasec® 2496, Huntsman), and 1250 g of modified MDI (Suprasec® 2020, Huntsman Shanghai) were reacted at 80° C. by a known method to give an NCO-terminated polyurethane polymer having a content of isocyanate groups of 11% by weight.

### Polymer-18 (Polymer P1-1):

1200 g polyoxypropylenepolyoxyethylene diol (VORANOL EP-1900), 250 g polybutadiene diol(POLYVEST HT, OH value 44-51 mgKOH/g), 1000 g of polymeric MDI (4,4′-methylene diphenyl diisocyanate) (Suprasec© 2496, Huntsman), and 1250 g of modified MDI (Suprasec® 2020, Huntsman Shanghai) were reacted at 80° C. by a known method to give an NCO-terminated polyurethane polymer having a content of isocyanate groups of 9.4% by weight.

### Preparation of Polyurethane Compositions

For each composition, the ingredients of the first component A specified in the tables were processed in the amounts specified (in parts by weight or wt.-%), by means of a vacuum dissolver with the exclusion of moisture, into a homogeneous paste and stored. The ingredients of the second component B specified in the tables were processed in similar manner and stored. The two components were then processed for 30 seconds in a mixing ratio of 1:1, by means of a jetting machine ZST-2K-Jet300, into a homogeneous paste, which was immediately tested as follows:

To determine the mechanical properties, the adhesive was fashioned into a dumbbell shape according to ISO 37, type 3, and cured/stored at 23° C. and 50% RH (relative humidity) for the time specified in the tables (7 days at 23° C.). After a conditioning period of 24 h at 23° C. and 50% RH, the tensile strength of the test specimens thus produced were measured according to ISO 37 on a Zwick Z020 tensile tester at 23° C. and 50% RH and a testing speed of 10 mm/min.

To measure the final lap shear strength, various test specimens were produced, in each case by applying the adhesive bead on a first PC plate and then placing under pressure a second PC plate on it to form an adhesive surface of 1-2 mm×0.7 mm. After the test specimens were stored and cured for 7 days at 23° C., the lap shear strength was determined according to ISO 4587 with 10 mm/mins speed.

To measure the chemical resistance, the specimens as prepared in the lap shear strength test were immersed in a 1:1 mixture of oleic acid and squalene for 3 days. Then, they were taken out and wiped clean. They were tested again for the lap shear strength and the tested results were compared with the normal lap shear strength (without immersion) for the decrease in percentage. Smaller decrease percentage means better chemical resistance.

To measure the sprayability, the device ZST-2K-Jet300 was adjusted to a certain pressure (generally 0.2 MPa) to spray the adhesive after mixing A and B components in the mixing tube onto the surface to be bonded through the nozzle. The nozzle was 4 mm away from the substrate. The adhesive was applied in form of a straight line or a circular arc, and the size of the applied bead was then measured for the width and height. The size having a height to width ratio of greater than 0.8 was ranked as good, otherwise it was ranked as poor. After stopping the spraying, the spraying nozzle was observed for the phenomenon of sagging. If no sagging, it was ranked as good. But, if sagging or even difficult in spraying under the same pressure, it was ranked as poor.

During the final lap shear strength testing, the specimens were observed for the failure mode on the substrate after removal of the adhesives from the substrate. Cohesive failure (CF) occurs when a fracture allows a layer of adhesive to remain on both surfaces. Adhesion failure (AF) refers to the state when the adhesive loses adhesion from one of the bonding surfaces. The occurrence probability of AF or CF was recorded in % among the testing specimens. For example, if AF occurs on five out of ten specimens, 50% was recorded.

Adhesion failure is especially desired in the electronic market in particular for repairing some electronic elements like glass screen which may be expensive and not allow any cracks.

TABLE 1
Compositions of individual examples

| | | | | | | | |
|---|---|---|---|---|---|---|---|
| No. | Ex1 | Ex2 | Ex3 | Ref1 | Ref2 | Ref3 | Ref4 |

Component A (parts by weight)

| | | | | | | | |
|---|---|---|---|---|---|---|---|
| Polyether polyol 1 | 22.70 | 20.20 | 20.20 | 56.00 | 1.20 | 37.20 | 37.20 |
| 1,5-PDO | 9.00 | 7.50 | 7.50 | 9.00 | 9.00 | 6.00 | 6.00 |
| CHP-H45 | 29.50 | 29.50 | 29.50 | — | 55.00 | — | — |
| Polyether polyol 2 | — | 4.00 | 4.00 | — | — | — | — |
| Voranol EP 1900 | — | — | — | — | — | 18.00 | 18.00 |
| GDMP | 4.00 | 4.00 | 4.00 | 4.00 | 4.00 | 4.00 | 4.00 |
| Bi-cat | 0.20 | 0.20 | 0.20 | 0.20 | 0.20 | 0.20 | 0.20 |
| Defoamer | 0.10 | 0.10 | 0.10 | 0.10 | 0.10 | 0.10 | 0.10 |
| Chalk | 26.50 | 29.50 | 29.50 | 22.70 | 26.50 | 24.50 | 24.50 |
| HDK-H18 | 8.00 | 5.00 | 5.00 | 8.00 | 4.00 | 10.00 | 10.00 |
| total | 100 | 100 | 100 | 100 | 100 | 100 | 100 |

Component B (parts by weight)

| | | | | | | | |
|---|---|---|---|---|---|---|---|
| Polymer-10 | 45.00 | — | — | 45.00 | 45.00 | — | — |
| Polymer-18 | — | — | 67.00 | — | — | 67.00 | — |
| Suprasec | 26.00 | — | 5.00 | 26.00 | 26.00 | 5.00 | — |
| 2020/Coronate MX | | | | | | | |
| Polymer-7 | — | 46.00 | — | — | — | — | 46.00 |
| Suprasec 2496 | — | 26.00 | — | — | — | — | 26.00 |
| PTSI | 0.80 | 0.80 | 0.80 | 0.80 | 0.80 | 0.80 | 0.80 |
| Kaolin | 6.60 | 6.60 | 6.60 | 6.60 | 6.60 | 6.60 | 6.60 |
| Monarch 570 | 10.00 | 5.00 | 12.00 | 10.00 | 10.00 | 12.00 | 5.00 |
| Chalk | 9.60 | 13.60 | 7.60 | 9.60 | 9.60 | 6.60 | 13.60 |
| Molecular sieve | 2.00 | 2.00 | 2.00 | 2.00 | 2.00 | 2.00 | 2.00 |
| total | 100 | 100 | 100 | 100 | 100 | 100 | 100 |

Mixing ratio of A:B is 1:1 by weight

TABLE 2
Properties measured for individual examples

| Properties | Ex1 | Ex2 | Ex3 | Ref1 | Ref2 | Ref3 | Ref4 |
|---|---|---|---|---|---|---|---|
| Sprayability: | | | | | | | |
| Size | good | good | good | poor | good | good | good |
| Sagging | good | good | good | poor | poor | good | good |
| Tensile strength, MPa | 20 | 15 | 10.2 | 12 | 23 | 9 | 9 |
| Final lap shear | 15.6 | 11.3 | 10.5 | 9.3 | 11 | 6.7 | 6.8 |
| strength, MPa | | | | | | | |
| Failure mode on | 100% AF | 100% AF | 100% AF | 30% CF/ | 80% CF/ | 100% AF | 100% AF |
| substrate | | | | 70% AF | 20% AF | | |
| Chemical resistance | 15% | 16% | 16% | 17% | 18% | 18% | 20% |

1. A polyurethane composition consisting of a first and a second component; wherein
the first component A comprises
at least one polyol A1 having an OH functionality in the range from 1.5 to 4 and a mean molecular weight in the range from 250 to 15 000 g/mol, and
at least one diol A2 having two hydroxyl groups that are linked via a C2 to C9 carbon chain, and
at least one compound T that has at least one thiol group; and
the second component B comprises
at least one polyisocyanate I;
wherein one of the two components additionally comprises at least one metal catalyst K for the reaction of hydroxyl groups and isocyanate groups that is able to form thio complexes;
the first component A comprises an acrylonitrile and styrene grafted polyether polyol H in a range of 7.5-25% by weight, and
the second component B comprises an isocyanate-group containing prepolymer P1, selected from either a polymer P1-1 based on at least one polyisocyanate, at least one polyether polyol and at least one hydroxy-terminated polybutadiene polymer, or from a polymer P1-2, based on at least one polyisocyanate and at least one polyether polyol.

2. The polyurethane composition as claimed in claim 1, wherein the metal catalyst K comprises a bismuth(III) compound.

3. The polyurethane composition as claimed in claim 2, wherein the bismuth(III) compound additionally contains an 8-hydroxyquinoline ligand or a 1,3-ketoamide ligand.

4. The polyurethane composition as claimed in claim 1, wherein the diol A2 is a linear aliphatic diol having two primary hydroxyl groups that are linked via a C4 to C9 carbon chain, in particular selected from the group consisting of 1,4-butanediol, 1,5-pentanediol, 1,6-hexanediol, and 1,9-nonanediol.

5. The polyurethane composition as claimed in claim 1, wherein the at least one compound T comprises a polythiol compound having 2 to 6 thiol groups, or a mercaptosilane.

6. The polyurethane composition as claimed in claim 5, wherein the at least one compound T is selected from the group consisting of ethylene glycol di(3-mercaptopropionate), ethylene glycol dimercaptoacetate, dipentaerythritol hexa(3-mercaptopropionate), and 3-mercaptopropyltrimethoxysilane.

7. The polyurethane composition as claimed in claim 1, wherein the molar ratio of all the thiol groups in the at least one compound T to all metal atoms in the at least one metal catalyst K is between 1:1 and 250:1.

8. The polyurethane composition as claimed in claim 1, wherein the metal catalyst K is present in the first component A.

9. The polyurethane composition as claimed in claim 1, wherein the amount of the polyether polyol H is in a range of 12.0-20.0% by weight based on the overall polyurethane composition.

10. The polyurethane composition as claimed in claim 1, wherein the amount of the isocyanate-group containing prepolymer P1 is in a range of 10% to 40% by weight.

11. A process for bonding substrates, including the steps of:
mixing the first and second components of the polyurethane composition as described above,
spraying the mixed composition onto at least one of the substrate surfaces to be bonded,
joining the substrates to be bonded within the pot life, and
curing the polyurethane composition.

12. The process as claimed in claim 11, wherein the substrates may consist of the same material or different materials made of a metal or a glass ceramic or a glass or a glass fiber-reinforced plastic or a carbon fiber-reinforced plastic or an epoxy-based thermoset.

13. The process as claimed in claim 11, wherein the substrates are the parts of an electric device such as audio and video apparatus, information technology equipment, telecommunication terminal equipment, portable electronic devices, for example laptop, mobile phone, pad, tablet and so on.
